(19) United States
(12) Patent Application Publication
(10) Pub. No.: US 2025/0216566 A1
(43) Pub. Date: Jul. 3, 2025

(54) Predicting Seismic Velocities for a Subsurface Formation

(71) Applicant: Saudi Arabian Oil Company, Dhahran (SA)

(72) Inventors: Daniele Colombo, Dhahran (SA); Ersan Turkoglu, Dhahran (SA); Ernesto Sandoval Curiel, Dhahran (SA); Taqi Yousuf Alyousuf, Sayhat (SA)

(21) Appl. No.: 18/401,998

(22) Filed: Jan. 2, 2024

(51) Int. Cl. G01V 1/28; G01V 1/30

(52) U.S. Cl. CPC G01V 1/282; G01V 1/303; G01V 2210/614; G01V 2210/6222

(57) ABSTRACT

Systems and methods for predicting seismic velocities for a subsurface formation include obtaining seismic data from a subsurface formation. The seismic data includes an amount of information about the seismic formation. A reduced seismic dataset is generated by applying an unsupervised machine learning model to cluster the seismic data. The reduced seismic dataset has less data than the seismic data, and the reduced seismic dataset includes the amount of information about the subsurface formation. Inversion models and forward modeling data are generated by performing a full waveform inversion for the reduced seismic dataset. The inversion models specify velocities in the subsurface formation and the forward modeling data specify response values of the inversion models. A supervised machine learning model is trained using the inversion models and the forward modeling data; and seismic velocities are predicted by providing the seismic data as input to the trained supervised machine learning model.

### TECHNICAL FIELD

This disclosure relates to geological exploration of a subsurface formation. Specifically, this disclosure relates to imaging of a subsurface based on performance of full waveform inversion (FWI) of seismic data representing a near-surface region.

### BACKGROUND

In geology, sedimentary facies are bodies of sediment that are recognizably distinct from adjacent sediments that resulted from different depositional environments. Geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications such as, for example, identification of potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

### SUMMARY

Geophysical characterization of the near surface can be performed for seismic exploration on land and shallow water. Reconstruction of the subsurface using seismic data can be difficult because of rapid lateral and vertical variations of elastic parameters of the subsurface. The accurate mapping of the near surface velocity in land seismic surveys and in shallow water seismic surveys enable the accurate imaging of the subsurface for oil and gas exploration and for monitoring or surveillance.

Characterization of the near surface is useful for sustainability objectives such as monitoring underground carbon dioxide (CO₂) storage to detect weak time-lapse signals generated from fluids in the reservoir. Seismic measurements are taken over specified time intervals to detect time-lapse variations of the seismic response related to changes of fluid concentration in the reservoir. Such time-lapse changes can occur in the time of the seismic arrival (e.g., seismic phase travel time variation) and/or in the amplitude of the reflected waves from the reservoir. Changes in the near surface (e.g., seasonal changes, water saturation, etc.) introduce distortions in the seismic wave propagations for both phase and amplitude, which can be characterized for successive corrections.

High-resolution characterization of the near surface is useful for identifying shallow geohazards such as detecting shallow cavities prone to causing collapses during drilling operations. Extended utilization of the near surface imaging techniques can also affect water, mineral, geothermal and natural hydrogen exploration and provide the background for geotechnical investigations, for example, for drill pad constructions.

This disclosure describes systems and methods for characterizing a subsurface formation. A data processing system (e.g., a computer or a control system) obtains seismic data from a subsurface formation. The data processing system generates a reduced seismic dataset by applying an unsupervised machine learning model to cluster the seismic data. The data processing system generates inversion models and labeled training data by performing a full waveform inversion for the reduced seismic dataset. The data processing system trains a supervised machine learning model using the inversion models and the labeled training data. The data processing predicts seismic velocities for the subsurface formation by providing the seismic data as input to the trained supervised machine learning model.

Full waveform inversion (FWI) is a geophysical inversion technique for generating velocity models from seismic data. The velocity models (for P-waves or S-waves-pressure or shear velocity, respectively) can be used for generating seismic images of the subsurface used for interpreting structures for drilling or for monitoring fluids in reservoirs. FWI provides an ill-posed inversion problem (e.g., small changes in the input data can cause significant changes in the solution). FWI is very expensive in terms of computing time (e.g., hours or days to generate a solution) and resource utilization (e.g., for sustainability objectives such as carbon reduction) because the machine learning models, used to interpret the subsurface structures, are pretrained. The standard pretraining of the machine learning models for FWI includes the generation of a large number of velocity parameter distributions for which a forward modeling operation is performed to associate the “observables” to the “velocity” labels. Modeling of the wave equation requires extensive computation of a large amount of training data, which represents a limiting factor for an effective implementation of machine learning models to the problem of seismic full waveform inversion. It is also unknown if the velocity parameter distributions used for the pre-training sufficiently sample the model space to represent the actual field data. The hypothetical model space distribution adopted for the machine learning pre-training may not match the distribution expressed by the field data, hence failing the objective of generating high resolution velocity models for obtaining high resolution seismic images.

The pretraining of the machine learning models can result in a large processing overhead to enable processing, by the data processing system, of the measured seismic data from the subsurface and generation of higher resolution seismic images. Because of the above limitations, effective applications of machine learning techniques to FWI have not been successful. In fact, a user must decide whether the benefits of obtaining the better resolution velocity model and successive high-resolution seismic images from machine learning FWI justify the enormous amount of computational and resource expenses involved.

To overcome these challenges, the systems and methods of this disclosure combine machine learning model types to reduce the computation time and associated cost for the data processing system to characterize the subsurface formation. Active learning, unsupervised learning, reinforcement learning, and supervised learning are types of machine learning models. The data processing system uses these models in combination to generate seismic velocity predictions for the subsurface formation in a self-supervised training process where the machine learning models learn directly from the data without a pretraining step. By combining the different types of machine learning models, a smaller training dataset (e.g., 1% or less of the whole dataset) can be used to train the machine learning models. The data processing system can reduce processing time and bandwidth usage for subsurface characterization and generation of the higher-resolution seismic images, thereby reducing processing resources (and their associated costs) for characterization of the subsurface and generation of the seismic images.

Implementations of the systems and methods of this disclosure can provide various technical benefits. This machine learning based FWI approach enables a sharp time reduction in the computation cost and generation of higher resolution results. For example, using the same computer platform, the machine learning based FWI applied to a specific area took 270 seconds(s) compared to 69,120 s used by the conventional FWI approach obtaining a 256× speed increment, or in other terms, the machine learning based FWI used 0.39% of the time spent by the conventional FWI approach. The computational resource savings correspond to a reduction in a carbon footprint of the computing facility by using less power.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey performed to map subsurface features such as facies and faults.

FIG. 2 illustrates a three-dimensional seismic cube representing a portion of a subsurface formation.

FIG. 3 illustrates a stratigraphic trace within a formation.

FIG. 4 is a flow chart for a self-supervised machine learning process.

FIG. 5 is a flow chart for a method of using machine learning paradigms for geophysical data inversion.

FIG. 6 is a flow chart for a method for machine learning based FWI of seismic data.

FIG. 7A is a plot of a machine learning process performance.

FIG. 7B is a plot of a trade-off curve between cluster RMS and the number of clusters.

FIG. 8 shows comparisons between results of the method of FIG. 6 with a conventional FWI.

FIG. 9 is a comparison of the performance of the method of FIG. 6 with a conventional FWI.

FIG. 10 is a flow chart of a method for predicting seismic velocities.

FIG. 11 illustrates hydrocarbon production operations that include field operations and computational operations, according to some implementations.

FIG. 12 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for characterizing a subsurface formation. A data processing system (e.g., a computer or a control system) obtains seismic data from a subsurface formation. The data processing system generates a reduced seismic dataset, relative to an initial seismic dataset, by applying an unsupervised machine learning model that clusters the seismic data. The clusters enable the data processing system to reduce an amount of data in the seismic dataset and preserve, in the reduced seismic dataset, information represented in the initial seismic dataset. The data processing system generates inversion models and training data by performing a full waveform inversion for the reduced seismic dataset. The inversion models executed by the data processing system are used to calculate forward response values. The data processing system trains a supervised machine learning model using the inversion models and the corresponding forward responses: the training data. The data processing predicts seismic velocities for the subsurface formation by providing the seismic data as input to the trained supervised machine learning model without pretraining the inversion models, reducing processing cost. The data processing system can generate seismic images with improved resolution based on FWI with a reduced processing cost relative to legacy FWI methods

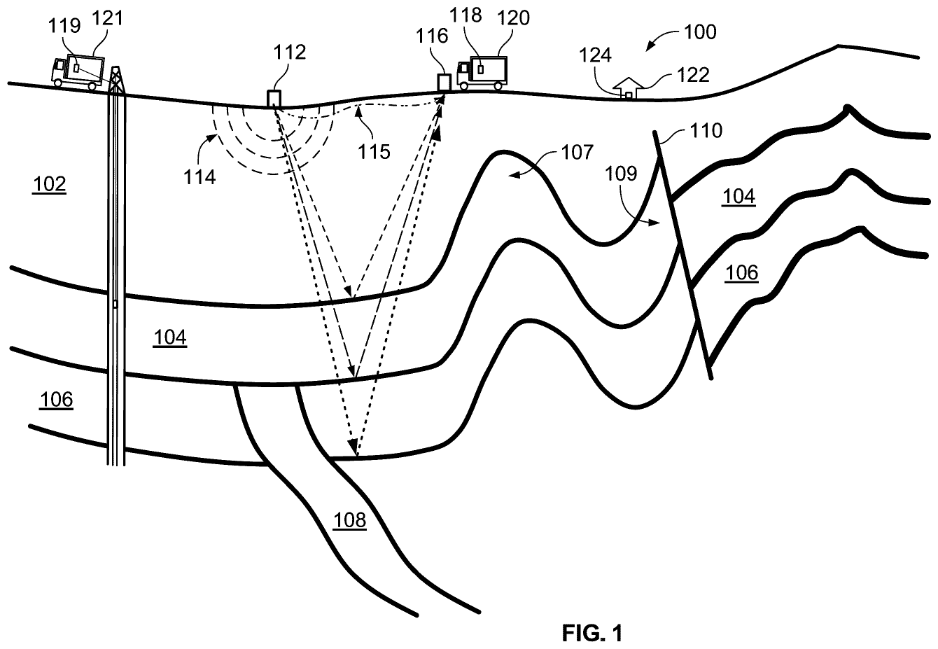

FIG. 1 is a schematic view of a seismic survey being performed to map subsurface features such as facies and faults in a subsurface formation 100. The subsurface formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subsurface formation 100, the velocity of seismic waves traveling through the subsurface formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subsurface formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subsurface formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subsurface formation or performing simulation, planning, and optimization of production operations of the wellsite systems.

In some implementations, results generated by the computer system 124 may be displayed for user viewing using local or remote monitors or other display units. One approach to analyzing seismic data is to associate the data with portions of a seismic cube representing the subsurface formation 100. The seismic cube can also display results of the analysis of the seismic data associated with the seismic survey.

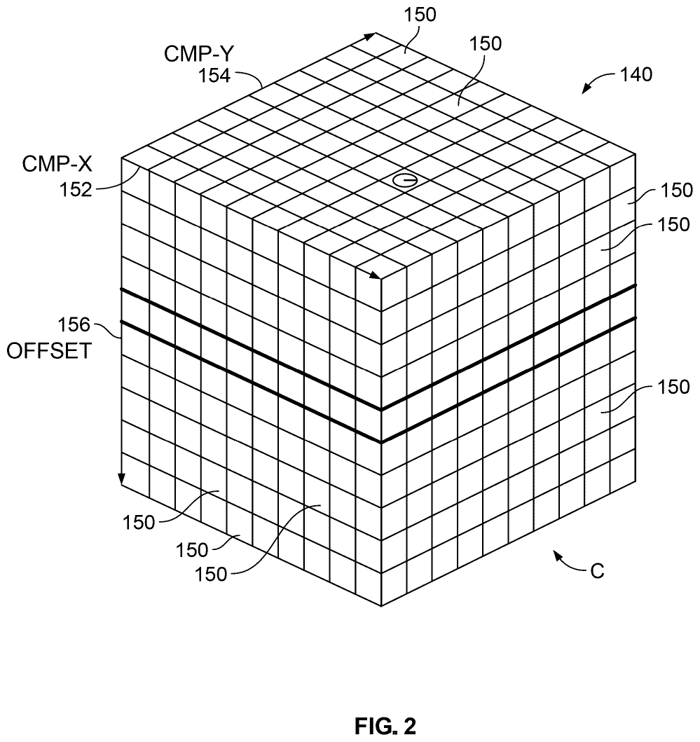

FIG. 2 illustrates a seismic cube 140 representing the seismic data. The seismic cube 140 is composed of a number of voxels 150. A voxel is a volume element, and each voxel contains seismic data, for example, seismic traces and its attributes such as first arrival travel times. The cubic volume C is composed along intersection axes of CMP-offset spacing data based on a Delta-X CMP-X spacing 152, a Delta-Y CMP-Y spacing 154, and a Delta-Offset offset spacing 156. Within each voxel 150, statistical analysis can be performed on data assigned to that voxel to determine, for example, multimodal distributions of traces attributes such as travel times and derive robust estimates (according to mean, median, mode, standard deviation, kurtosis, and other suitable statistical accuracy analytical measures) related to azimuthal sectors allocated to the voxel 150.

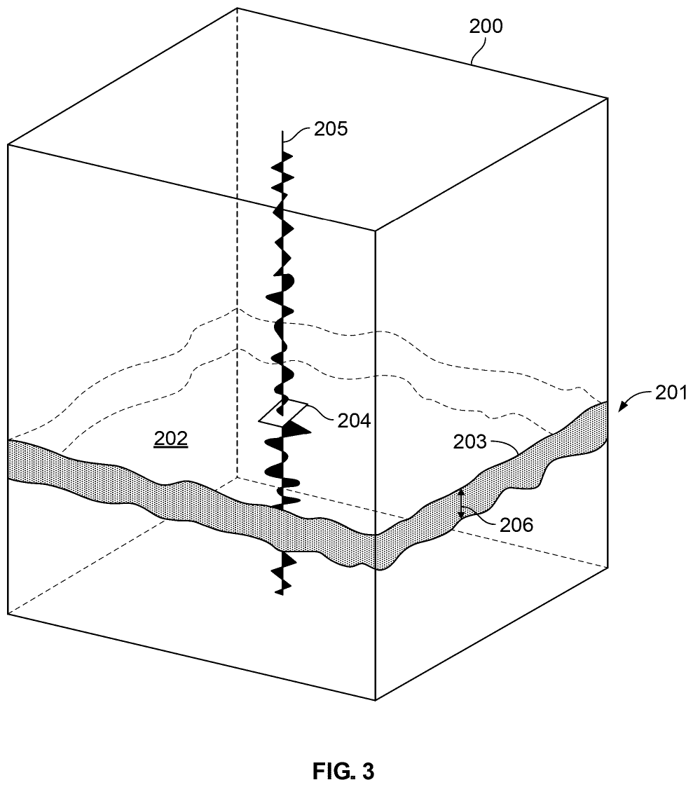

FIG. 3 illustrates a seismic cube 200 representing a formation. The seismic cube has a stratum 201 based on a surface (for example, amplitude surface 202) and a stratigraphic horizon 203. The amplitude surface 202 and the stratigraphic horizon 203 are grids that include many cells such as exemplary cell 204. Each cell is a seismic trace representing an acoustic wave. Each seismic trace has an x-coordinate and a y-coordinate, and each data point of the trace corresponds to a certain seismic travel time or depth (t or z). For the stratigraphic horizon 203, a time value is determined and then assigned to the cells from the stratum 201. For the amplitude surface 202, the amplitude value of the seismic trace at the time of the corresponding horizon is assigned to the cell. This assignment process is repeated for all of the cells on this horizon to generate the amplitude surface 202 for the stratum 201. In some instances, the amplitude values of the seismic trace 205 within window 206 by horizon 203 are combined to generate a compound amplitude value for stratum 201. In these instances, the compound amplitude value can be the arithmetic mean of the positive amplitudes within the duration of the window, multiplied by the number of seismic samples in the window.

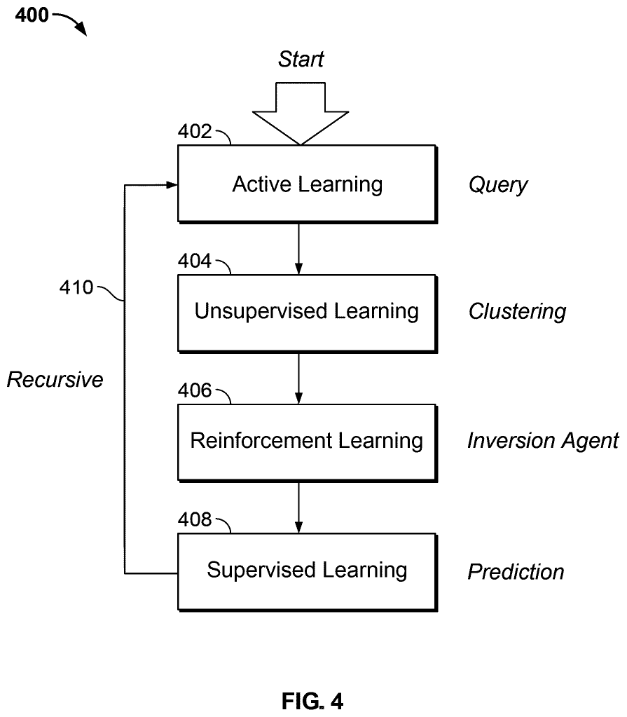

FIG. 4 is a flow chart for an example self-supervised machine learning process 400 that combines multiple learning paradigms for performing an inversion of geophysical data. The execution of the machine learning models can include executing models having different types. The process 400 includes executing an active learning model (step 402), unsupervised learning model (step 404), a reinforcement learning model (step 406), and a supervised learning model (step 408) are combined in a cascade followed by a recursive step 410. Execution of the active learning model (step 402) includes execution of a type of machine learning model where the machine learning model can interactively query an information source to label new data points with desired outputs. The active learning model is configured to learn better and faster relative to a generic machine learning model because the active learning model can decide what data to use for learning. Unsupervised learning (step 404) includes execution of a machine learning model type where the machine learning model learns patterns from unlabeled data. Reinforcement learning (step 406) includes execution of a machine learning model type where an intelligent agent, such as an agent having an objective function that takes actions autonomously in order to achieve goals, takes actions in an environment to maximize a reward. Supervised learning (step 408) includes execution of a machine learning model type where each of input data and output data are used to train the machine learning model. In this example, a trained supervised machine learning model is configured to predict values for previously unseen input data.

The sequential application of the learning model types is iterated (step 410) until a stopping criterion defined by the end of the learning process is reached. The stopping criterion indicates that the machine learning scheme has stopped learning, and the results inferred at the last cycle are final. The process 400 is a self-supervised process for training a machine learning model where the requirement of an initial training is dropped. The machine learning model learns directly from the data without first pretraining the machine learning model.

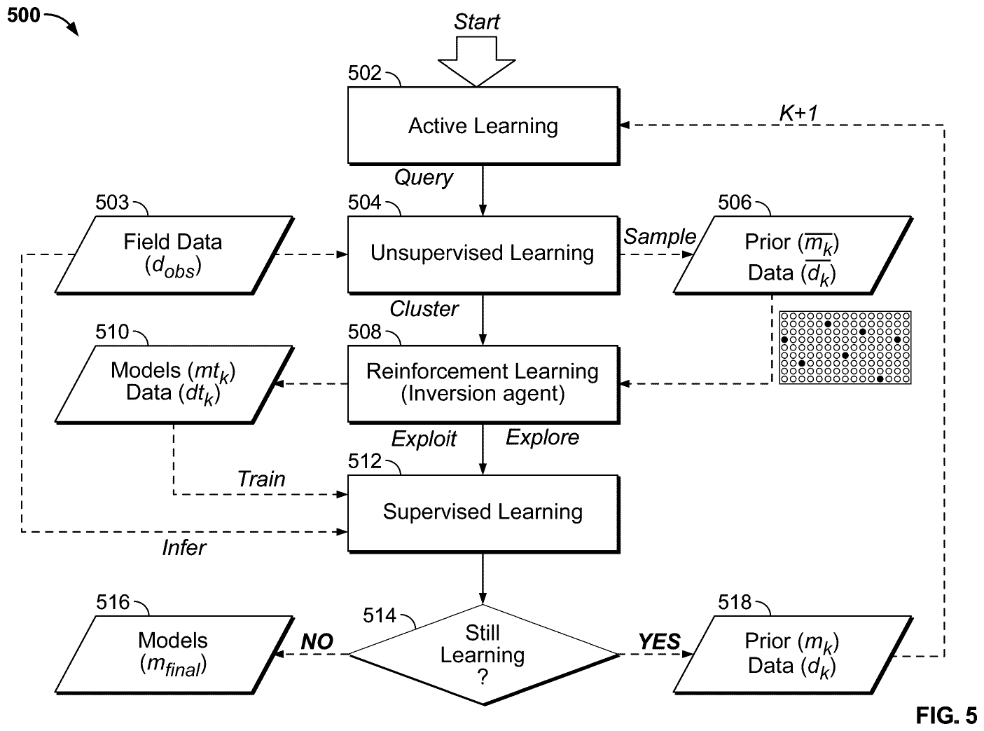

FIG. 5 is a flow chart of an example method 500 for using the self-supervised learning process 400 for geophysical data inversion. The method 500 can be implemented on a data processing system (e.g., a computer or control system).

The data processing system employs an active learning model 502 to generate a reduced data set 506 by allowing the active learning model to select the data from field data d_{obs} 503. This is realized through query frameworks using heuristics on diversity and uncertainty. An unsupervised learning model 504, such as a clustering model, implements the heuristics data. The clustering model can include a k-means model, a fuzzy c-means model, a hierarchical model, and so forth. For example, to assess data diversity, the active learning model 502 queries the unsupervised learning model 504 to form different numbers of clusters based on the field data 503. The active learning model selects a number of clusters where no further improvement in the cluster root mean square value is achieved by increasing the number of clusters.

The data processing system forms a reduced dataset 506 (m̅ₖ̅, d̅ₖ̅) by selecting data from each of the clusters formed by the unsupervised learning model 504. For example, the data processing system randomly samples a set number of data points from each cluster (e.g., sample 10 data points from each of 5 clusters for 50 total data points in the reduced dataset). The reduced datasets maintain the full information of the field data 503 by maintaining the diversity of the field data 503.

The data processing system applies a reinforcement learning model 508 to generate labeled training data 510. The intelligent agent (e.g., an inversion agent) of the reinforcement learning model 508 interacts with the environment (e.g., reduced dataset 506) to satisfy a data misfit reduction policy representing the reward. The data misfit at the first iteration is determined relative to a starting velocity model (Prior) For example, the starting velocity model can be a velocity gradient versus depth. The operation identifies a subset of models and data 510, mtₖ, dtₖ, (e.g., parameter distributions) based on the reduced dataset 506 that represent an approximation to the true parameter distribution. The data, dtₖ represents the forward responses corresponding to the models mtₖ.

The data processing system trains the supervised learning model 512 based on the subset of models and data 510 identified by the reinforcement learning model 508. The supervised machine learning model 512 can include, for example, an artificial neural network model or a gaussian process regression model. The supervised learning model 512 through training is based on approximations of the true model parameters as inferred by the intelligent agent through its interaction with the field data, e.g., no initial training is required by the method 500.

The data processing system predicts models (e.g., seismic velocity models) using the trained supervised learning model 512 and the field data 503. Based on the predicted models, the data processing systems evaluates if the learning process is complete or if more training examples are needed (block 514). The learning process can be verified by plotting the misfit reduction (e.g., root mean squared error (RMSE) or percentage mean squared error (% MSE)) of the predicted models versus cycle number. When the curve becomes flat (e.g., the slope falls below a threshold value), it indicates that the learning process has ended, and the generated models are final models 516. If the learning process is still ongoing (e.g., the slope is above the threshold value), the generated models become prior models 518 and the method returns to the active learning model 502 to start a new cycle.

After the first iteration of method 500, the active learning model 502 can query data uncertainty instead of data diversity. For example, the data processing system can estimate the root mean square error (RMSE) of the data for the generated models. The data processing system can extract large RMSE data through thresholding and random sampling. The extracted large RMSE data can be added to the reduced dataset 506 and used iterations of the reinforcement learning model 508.

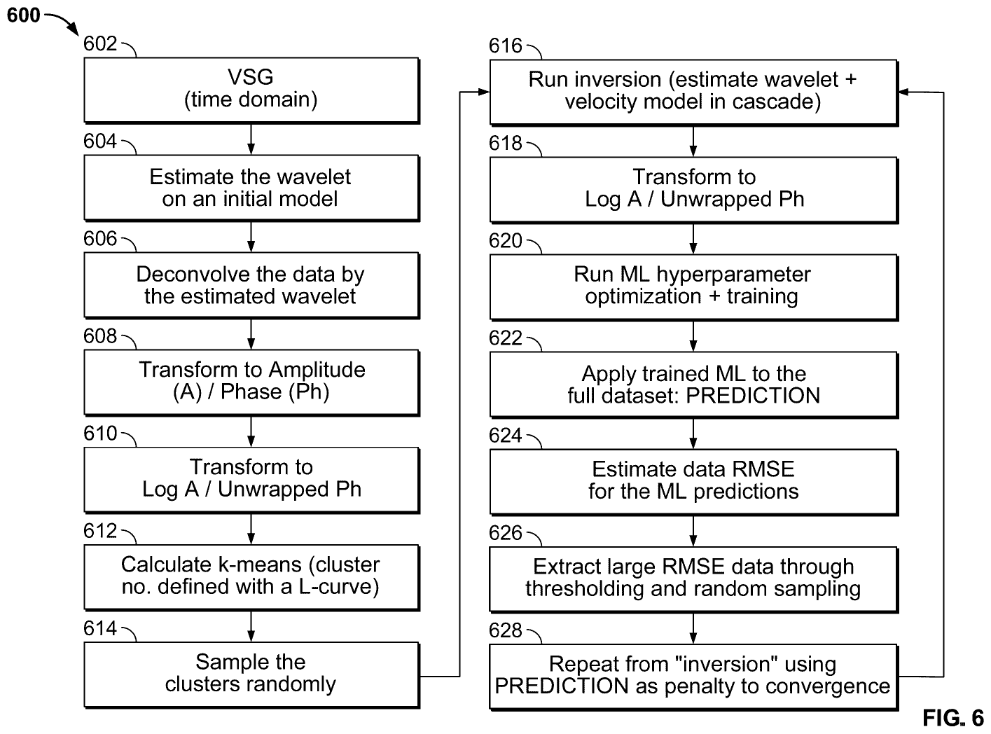

FIG. 6 is flow chart for an example method 600 for machine learning based FWI of seismic data. The method 600 includes the principles of the self-supervised machine learning process 400 and the method 500. The method 600 includes additional steps specific to FWI. The method 600 can be implemented on a data processing system. FWI can be an important process for characterizing the subsurface formation, for example, for enhancing resource exploration, exploitation and monitoring.

The data processing system obtains seismic data for the subsurface formation in a time domain (e.g., virtual super gathers (VSGs)) (step 602). The seismic data can be represented, for example, in the Laplace-Fourier domain which allows use of complex frequencies.

The data processing system estimates a wavelet using an initial velocity model (e.g., from travel time inversion) (step 604). For example, the data processing system uses a deterministic inversion such as a travel time inversion to estimate the wavelet. The wavelet represents distortions caused by the near surface. In some implementations, the wavelets are spatially varying.

The data processing system deconvolves the seismic data (e.g., VSG data) by the wavelet to reduce the influence of local near surface conditions (step 606). The deconvolution of the VSGs yields the seismic responses of the geology deeper in the subsurface formation.

The data processing system transforms the seismic data to an amplitude (A) (e.g., magnitude) and phase (Ph) representation to generate a data structure suitable for training a machine learning model (step 608). Example machine learning models include Artificial Neural Networks (ANN) or Gaussian Process (GP) regression.

In some implementations, the data processing system further transforms the A-Ph data into Log A and unwrapped Ph for generating a data structure more suitable for machine learning models (step 610).

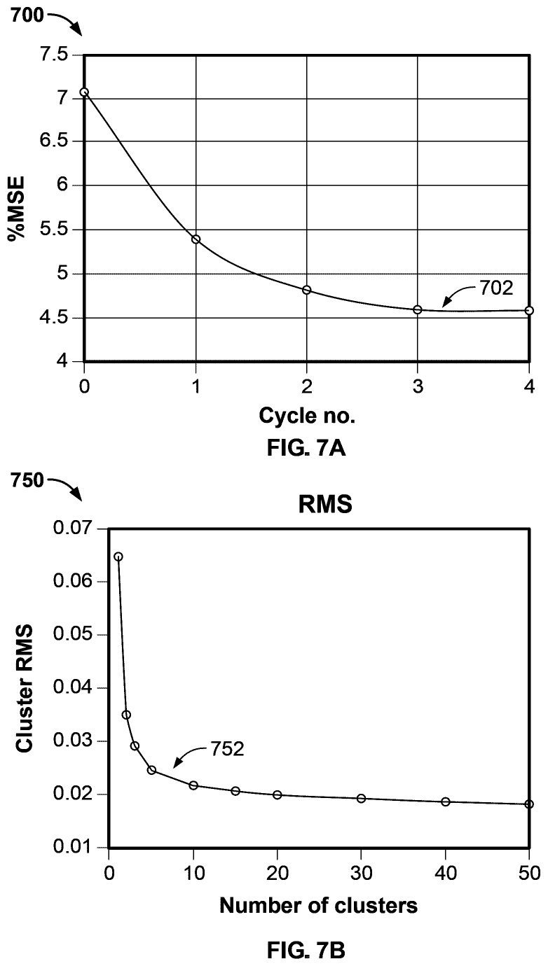

The data processing system applies an active learning paradigm to query the diversity of the data (step 612). For example, the data processing system performs clustering (e.g., k-means clustering) on the transformed VSG data. The data processing system can select an optimal number of clusters for the clustering algorithm using a cluster RMS versus number of clusters (e.g., an L-curve). An example L-curve is shown in FIG. 7B.

The data processing system samples the selected clusters to generate a first reduced dataset (step 614). For example, the data processing system randomly selects 5 samples from 10 clusters to generate a reduced dataset of 50 total samples. The reduced dataset can be a heavily reduced dataset for example include less than 1% of the total number of samples in the seismic data. Enough samples are included in the reduced dataset to enable training of the machine learning model. For example, the number of samples provide numerical stability to, for example, the seismic inversion and optimization algorithm of the machine learning model. In some implementations, the number of samples to extract from a cluster is user-defined.

The data processing system performs a FWI (e.g., a 1.5 D Laplace-Fourier inversion) on the reduced dataset generating inversion models and the corresponding forward responses (step 616). The details of the FWI method are given in Colombo, et al., U.S. Pat. No. 11,397,273, which is hereby incorporated by reference in its entirety. For simplicity, the geophysical method in this example method is a full waveform inversion in the midpoint-offset domain. This machine learning based FWI scheme can be easily extended to other sorting domains in any data dimensionality (e.g., 1D, 2D, 3D or 4D cases).

The data processing system transforms the modeled data (e.g., inversion models) to Log A and unwrapped Ph form (step 618).

The data processing system trains a supervised machine learning model (e.g., a GP regression) (step 620). In some implementations, the data processing system tunes the hyperparameters of the supervised machine learning model during training. For example, the data processing system can tune the hyperparameters using a Bayesian optimization, a grid search, or a random search.

The data processing system applies the trained supervised machine learning model (e.g., the GP regression) to the full seismic dataset (step 622). Application of the trained model generates predictions of the velocity model for the subsurface formation.

The data processing system estimates a data misfit (e.g., RMSE) for the machine learning predictions (step 624). For example, the data processing system forward models the predicted velocity models and calculates the RMSE between the forward modeled data and the seismic data (e.g., VSGs).

The data processing system extracts large RMSE data from the seismic data through thresholding and random sampling (step 626). The large RMSE data represents samples that were not adequately captured by the supervised machine learning model. The data processing system can add the extracted large RMSE data to the reduced dataset to be used in future iterations of the method.

The data processing system iterates steps 616-626 until the predicted velocity models converge (step 628). For each iteration, the data processing system can estimate a wavelet based on the predicted velocity models and deconvolve the reduced dataset with the wavelet. The total number of samples in the training dataset at the end of the procedure is dependent on convergence of the learning. Convergence can be determined from a learning process curve (e.g., % MSE versus iteration number). When the learning process curve flattens out, the learning process has stopped indicating no further improvement in the predicted velocity models can be achieved.

In an example implementation, the method 600 is implemented for a FWI of land seismic data. The area of application is characterized by a structure-controlled wadi with a complex velocity distribution. The seismic data are preconditioned with an original surface-consistent decomposition of the transmitted wavefield to account and compensate for effects occurring in the weathering section of the model. Details of the surface consistent compensation are given in U.S. Pat. No. 10,852,450, which is incorporated by reference in its entirety. The shallow near-surface kinematic and dynamic surface-consistent responses are deconvolved from the data together with the estimated wavelet. A signal-to-noise enhancement step is applied by generating midpoint-offset virtual super gathers (VSGs) representing the input to the 1.5D Laplace-Fourier FWI and machine learning training. A fully-connected artificial neural network (ANN) and a Gaussian process (GP) regression were tested.

FIG. 7A shows a learning process curve 700 from the example implementation of the method 600 to a complex land seismic dataset. After three iterations, the learning process has ended as indicated by the flattening 702 of the % MSE curve.

FIG. 7B shows a trade-off curve 750 (e.g., L-curve) for the example implementation representing the RMSE of cluster members versus the mean cluster function (e.g., cluster prototype) versus the number of clusters. The optimal segmentation is achieved at the knee 752 of the L-curve, in this case between 5 and 10 clusters.

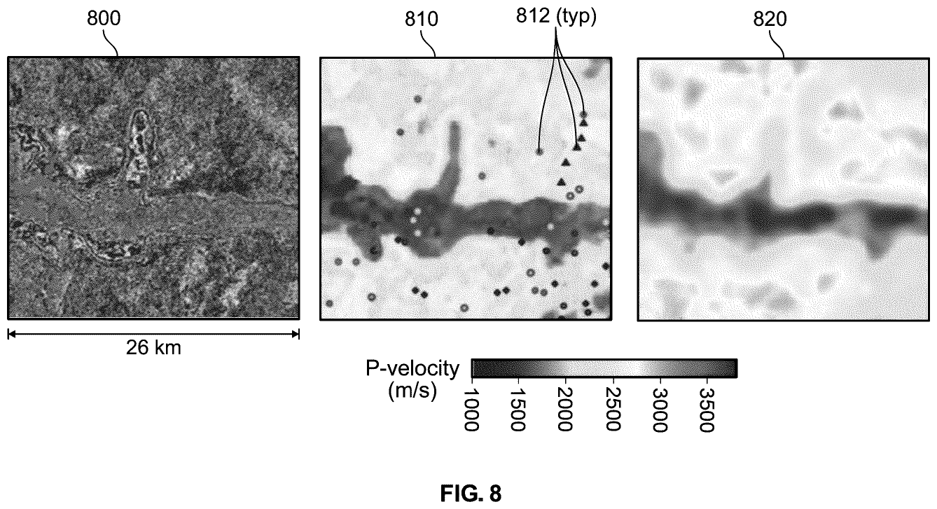

FIG. 8 shows results from the example implementation. A shallow time slice 800 of the seismic data at 164 ms (two way travel time, TWT) is compared to the velocity model 810 obtained from GP regression using 50 samples (e.g., VSGs) over the 15,800 VSGs available and over the 160,000 shot gathers (single fold) constituting the original seismic dataset. The symbols 812 in the velocity model 810 represent the locations of the 50 samples used for training the GP model. The comparison with a benchmark FWI 820 of the same area indicates that the method 600 is capable of achieving higher resolution than a conventional FWI scheme using only a small fraction of the data. This physics-adaptive scheme provides self-supervised learning directly from field data and drops the requirement of an initial training step. The successful application to large field survey of a complex land data FWI, suggests that the methodology is robust and can generalize well for any type of geophysical data.

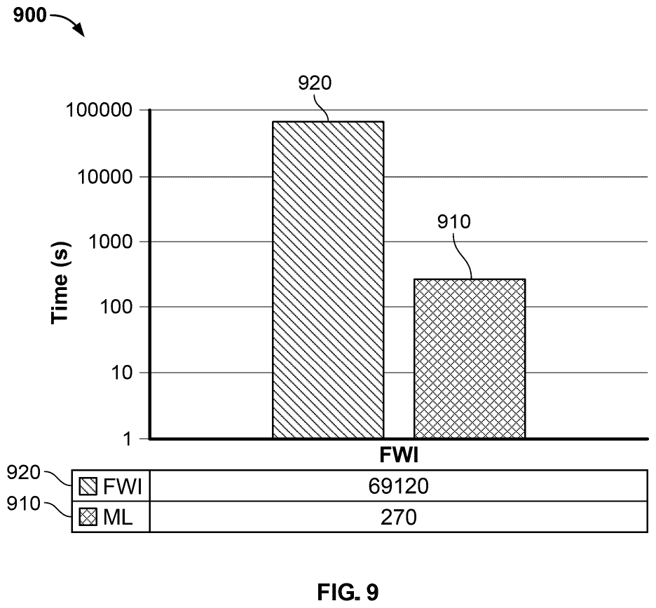

FIG. 9 shows a comparison 900 of the performance of the example implementation 910 of the method 600 with a conventional FWI method 920. The results for the example implementation displayed in FIG. 8 took 270 s compared to 69,120 s of the conventional FWI approach. The method 600 obtained a 256× speed increase, or in other words, the method 600 used 0.39% of the time spent by the conventional FWI approach. The exceptional performance translates to a fraction of the carbon emissions that would be generated by the conventional FWI process.

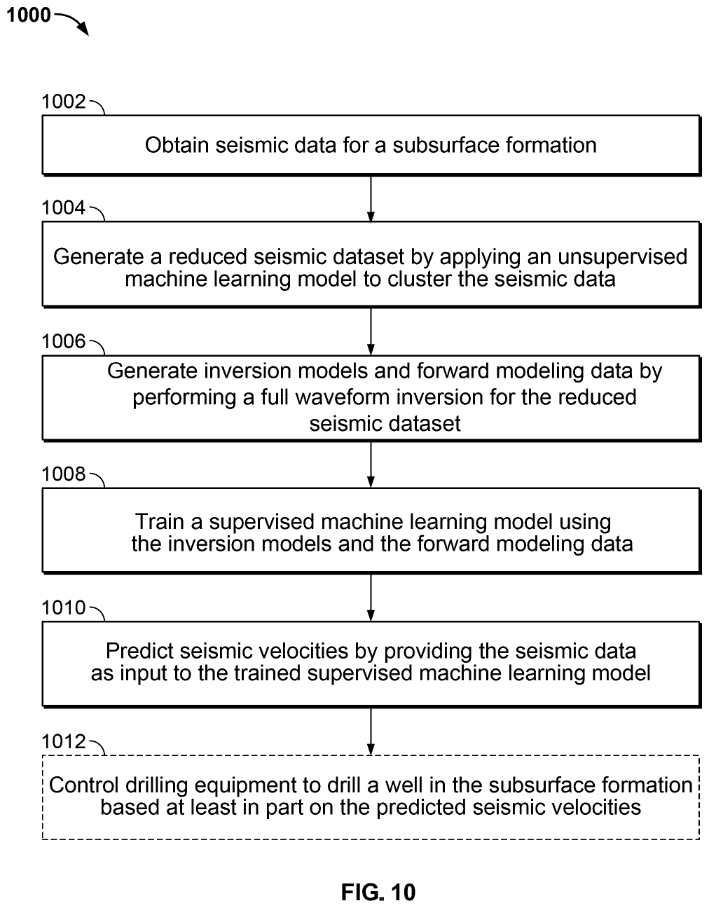

FIG. 10 is an example method 1000 for predicting seismic velocities for a subsurface formation. The method 1000 can be implemented on a data processing system (e.g., computer system 124 or computing system 1200).

A data processing system obtains seismic data from a subsurface formation (step 1002). For example, the data processing system obtains seismic data from a seismic survey operation (e.g., the seismic survey of FIG. 1). In some implementations, the data processing system obtains the seismic data by accessing a data store or a database. In some implementations, the data processing system transforms the seismic data to amplitude and phase data for use by unsupervised and supervised machine learning models.

The data processing system generates a reduced seismic dataset by applying an unsupervised machine learning model to cluster the seismic data (step 1004). For example, the data processing system can apply a k-means clustering model, a fuzzy c-means clustering model, or a hierarchical clustering model. In some implementations generating the reduced dataset includes applying an active learning model to determine a number of clusters to be formed by the unsupervised machine learning model. For example, the data processing system can determine the number of clusters based on a RMSE of each cluster with respect to the mean of each cluster and the number of clusters formed. In some implementations, the data processing system randomly selects samples from each cluster formed by the unsupervised machine learning model.

The data processing system generates inversion models and forward modeling data by performing a full waveform inversion for the reduced seismic dataset (step 1006).

The data processing system trains a supervised machine learning model using the inversion models and the forward modeling data (step 1008). For example, the supervised machine learning model can be an artificial neural network, a gaussian process regression model, or another machine learning model.

The data processing system predicts seismic velocities by providing the seismic data as input to the trained supervised machine learning model (step 1010).

The data processing system can control drilling equipment to drill a well in the subsurface formation based at least in part on the predicted seismic velocities (step 1012). For example, the predicted seismic velocities can indicate drilling hazards (e.g., cavities) that can cause the well to cave in. The data processing system can control the drilling equipment to avoid the indicated drilling hazards.

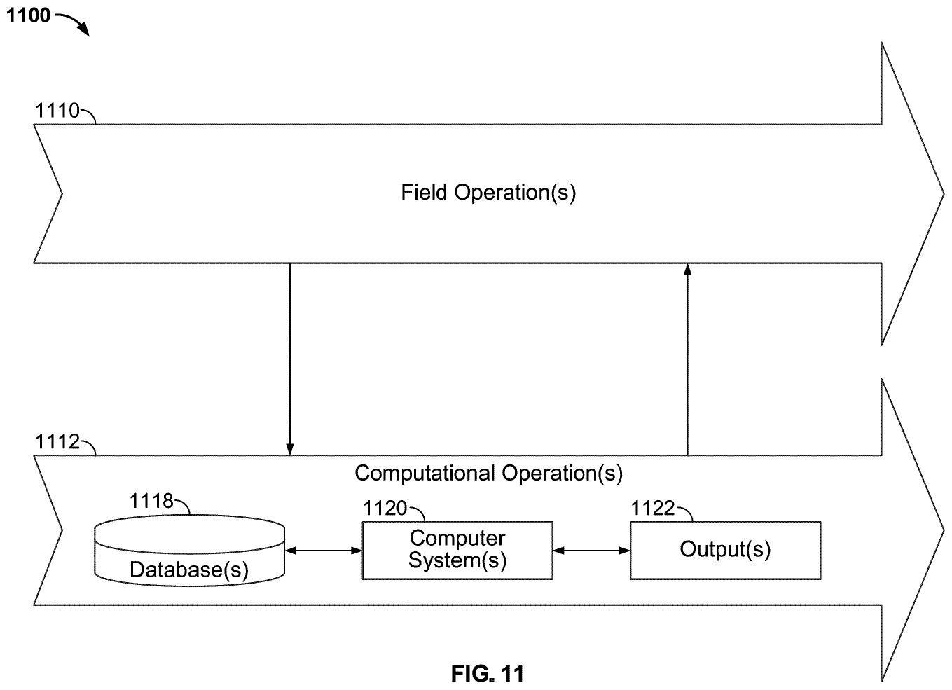

FIG. 11 illustrates hydrocarbon production operations 1100 that include both one or more field operations 1110 and one or more computational operations 1112, which exchange information and control exploration for the production of hydrocarbons. In some implementations, outputs of techniques of the present disclosure (e.g., the method 600 or method 1000) can be performed before, during, or in combination with the hydrocarbon production operations 1100, specifically, for example, either as field operations 1110 or computational operations 1112, or both.

Examples of field operations 1110 include forming/drilling a wellbore, hydraulic fracturing, producing through the wellbore, injecting fluids (such as water) through the wellbore, to name a few. In some implementations, methods of the present disclosure can trigger or control the field operations 1110. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1110 and responsively triggering the field operations 1110 including, for example, generating plans and signals that provide feedback to and control physical components of the field operations 1110. Alternatively, or in addition, the field operations 1110 can trigger the methods of the present disclosure. For example, implementing physical components (including, for example, hardware, such as sensors) deployed in the field operations 1110 can generate plans and signals that can be provided as input or feedback (or both) to the methods of the present disclosure.

Examples of computational operations 1112 include one or more computer systems 1120 that include one or more processors and computer-readable media (e.g., non-transitory computer-readable media) operatively coupled to the one or more processors to execute computer operations to perform the methods of the present disclosure. The computational operations 1112 can be implemented using one or more databases 1118, which store data received from the field operations 1110 and/or generated internally within the computational operations 1112 (e.g., by implementing the methods of the present disclosure) or both. For example, the one or more computer systems 1120 process inputs from the field operations 1110 to assess conditions in the physical world, the outputs of which are stored in the databases 1118. For example, seismic sensors of the field operations 1110 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1112 where they are stored in the databases 1118 and analyzed by the one or more computer systems 1120.

In some implementations, one or more outputs 1122 generated by the one or more computer systems 1120 can be provided as feedback/input to the field operations 1110 (either as direct input or stored in the databases 1118). The field operations 1110 can use the feedback/input to control physical components used to perform the field operations 1110 in the real world.

For example, the computational operations 1112 can process the seismic data to generate three-dimensional (3D) maps of the subsurface formation. The computational operations 1112 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1112 to process new information about the formation and control the drilling to adjust to the observed conditions in real-time.

The one or more computer systems 1120 can update the 3D maps of the subsurface formation as information from one exploration well is received and the computational operations 1112 can adjust the location of the next exploration well based on the updated 3D maps. Similarly, the data received from production operations can be used by the computational operations 1112 to control components of the production operations. For example, production well and pipeline data can be analyzed to predict slugging in pipelines leading to a refinery and the computational operations 1112 can control machine operated valves upstream of the refinery to reduce the likelihood of plant disruptions that run the risk of taking the plant offline.

In some implementations of the computational operations 1112, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

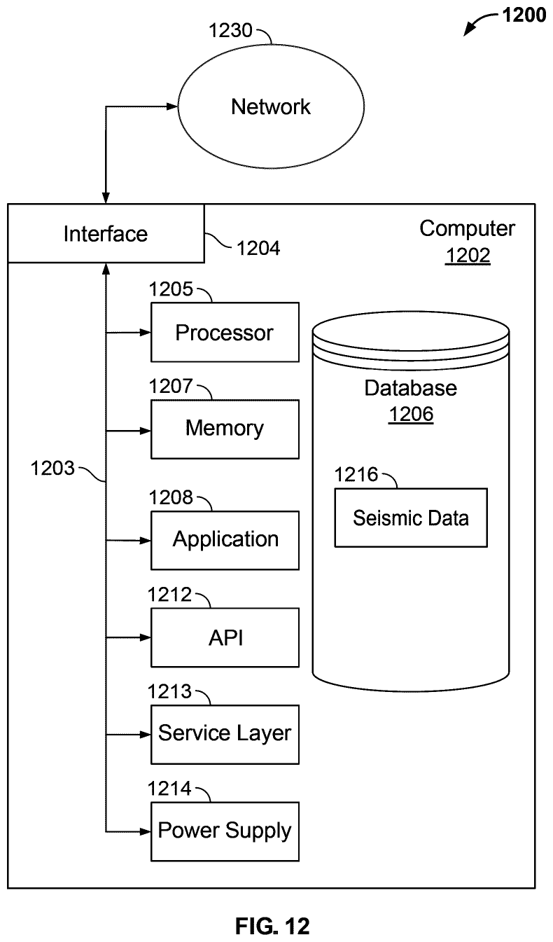

FIG. 12 is a block diagram of an example computer system 1200 used to provide computational functionalities associated with described algorithms, methods, functions, processes, flows, and procedures described in the present disclosure, according to some implementations of the present disclosure. The illustrated computer 1202 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1202 can include input devices such as keypads, keyboards, and touch screens that can accept user information. Also, the computer 1202 can include output devices that can convey information associated with the operation of the computer 1202. The information can include digital data, visual data, audio information, or a combination of information. The information can be presented in a graphical user interface (UI) (or GUI).

The computer 1202 can serve in a role as a client, a network component, a server, a database, a persistency, or components of a computer system for performing the subject matter described in the present disclosure. The illustrated computer 1202 is communicably coupled with a network 1230. In some implementations, one or more components of the computer 1202 can be configured to operate within different environments, including cloud-computing-based environments, local environments, global environments, and combinations of environments.

At a high level, the computer 1202 is an electronic computing device operable to receive, transmit, process, store, and manage data and information associated with the described subject matter. According to some implementations, the computer 1202 can also include, or be communicably coupled with, an application server, an email server, a web server, a caching server, a streaming data server, or a combination of servers.

The computer 1202 can receive requests over network 1230 from a client application (for example, executing on another computer 1202). The computer 1202 can respond to the received requests by processing the received requests using software applications. Requests can also be sent to the computer 1202 from internal users (for example, from a command console), external (or third) parties, automated applications, entities, individuals, systems, and computers.

Each of the components of the computer 1202 can communicate using a system bus 1203. In some implementations, any or all of the components of the computer 1202, including hardware or software components, can interface with each other or the interface 1204 (or a combination of both), over the system bus 1203. Interfaces can use an application programming interface (API) 1212, a service layer 1213, or a combination of the API 1212 and service layer 1213. The API 1212 can include specifications for routines, data structures, and object classes. The API 1212 can be either computer-language independent or dependent. The API 1212 can refer to a complete interface, a single function, or a set of APIs.

The service layer 1213 can provide software services to the computer 1202 and other components (whether illustrated or not) that are communicably coupled to the computer 1202. The functionality of the computer 1202 can be accessible for all service consumers using this service layer. Software services, such as those provided by the service layer 1213, can provide reusable, defined functionalities through a defined interface. For example, the interface can be software written in JAVA, C++, or a language providing data in extensible markup language (XML) format. While illustrated as an integrated component of the computer 1202, in alternative implementations, the API 1212 or the service layer 1213 can be stand-alone components in relation to other components of the computer 1202 and other components communicably coupled to the computer 1202. Moreover, any or all parts of the API 1212 or the service layer 1213 can be implemented as child or sub-modules of another software module, enterprise application, or hardware module without departing from the scope of the present disclosure.

The computer 1202 includes an interface 1204. Although illustrated as a single interface 1204 in FIG. 12, two or more interfaces 1204 can be used according to particular needs, desires, or particular implementations of the computer 1202 and the described functionality. The interface 1204 can be used by the computer 1202 for communicating with other systems that are connected to the network 1230 (whether illustrated or not) in a distributed environment. Generally, the interface 1204 can include, or be implemented using, logic encoded in software or hardware (or a combination of software and hardware) operable to communicate with the network 1230. More specifically, the interface 1204 can include software supporting one or more communication protocols associated with communications. As such, the network 1230 or the interface's hardware can be operable to communicate physical signals within and outside of the illustrated computer 1202.

The computer 1202 includes a processor 1205. Although illustrated as a single processor 1205 in FIG. 12, two or more processors 1205 can be used according to particular needs, desires, or particular implementations of the computer 1202 and the described functionality. Generally, the processor 1205 can execute instructions and can manipulate data to perform the operations of the computer 1202, including operations using algorithms, methods, functions, processes, flows, and procedures as described in the present disclosure.

The computer 1202 also includes a database 1206 that can hold data for the computer 1202 and other components connected to the network 1230 (whether illustrated or not). For example, database 1206 can hold seismic data 1216. For example, database 1206 can be an in-memory, conventional, or a database storing data consistent with the present disclosure. In some implementations, database 1206 can be a combination of two or more different database types (for example, hybrid in-memory and conventional databases) according to particular needs, desires, or particular implementations of the computer 1202 and the described functionality. Although illustrated as a single database 1206 in FIG. 12, two or more databases (of the same, different, or combination of types) can be used according to particular needs, desires, or particular implementations of the computer 1202 and the described functionality. While database 1206 is illustrated as an internal component of the computer 1202, in alternative implementations, database 1206 can be external to the computer 1202.

The computer 1202 also includes a memory 1207 that can hold data for the computer 1202 or a combination of components connected to the network 1230 (whether illustrated or not). Memory 1207 can store any data consistent with the present disclosure. In some implementations, memory 1207 can be a combination of two or more different types of memory (for example, a combination of semiconductor and magnetic storage) according to particular needs, desires, or particular implementations of the computer 1202 and the described functionality. Although illustrated as a single memory 1207 in FIG. 12, two or more memories 1207 (of the same, different, or combination of types) can be used according to particular needs, desires, or particular implementations of the computer 1202 and the described functionality. While memory 1207 is illustrated as an internal component of the computer 1202, in alternative implementations, memory 1207 can be external to the computer 1202.

The application 1208 can be an algorithmic software engine providing functionality according to particular needs, desires, or particular implementations of the computer 1202 and the described functionality. For example, application 1208 can serve as one or more components, modules, or applications. Further, although illustrated as a single application 1208, the application 1208 can be implemented as multiple applications 1208 on the computer 1202. In addition, although illustrated as internal to the computer 1202, in alternative implementations, the application 1208 can be external to the computer 1202.

The computer 1202 can also include a power supply 1214. The power supply 1214 can include a rechargeable or non-rechargeable battery that can be configured to be either user- or non-user-replaceable. In some implementations, the power supply 1214 can include power-conversion and management circuits, including recharging, standby, and power management functionalities. In some implementations, the power-supply 1214 can include a power plug to allow the computer 1202 to be plugged into a wall socket or a power source to, for example, power the computer 1202 or recharge a rechargeable battery.

There can be any number of computers 1202 associated with, or external to, a computer system containing computer 1202, with each computer 1202 communicating over network 1230. Further, the terms “client,” “user,” and other appropriate terminology can be used interchangeably, as appropriate, without departing from the scope of the present disclosure. Moreover, the present disclosure contemplates that many users can use one computer 1202 and one user can use multiple computers 1202.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### EXAMPLES

In an example implementation, a method for predicting seismic velocities for a subsurface formation includes obtaining seismic data from a subsurface formation, the seismic data including an amount of information about the seismic formation; generating a reduced seismic dataset by applying an unsupervised machine learning model to cluster the seismic data, the reduced seismic dataset having less data than the seismic data, the reduced seismic dataset including the amount of information about the subsurface formation; generating inversion models and forward modeling data by performing a full waveform inversion for the reduced seismic dataset, wherein the inversion models specify velocities in the subsurface formation and the forward modeling data specify response values of the inversion models; training a supervised machine learning model using the inversion models and the forward modeling data; and predicting seismic velocities by providing the seismic data as input to the trained supervised machine learning model.

An aspect combinable with the example implementation includes generating, based on the predicted seismic velocities, a seismic image having an improved resolution, resulting from performing the full waveform inversion and relative to seismic images generated without performing full waveform inversion, where generating the seismic image has a reduced computation cost relative to performing full waveform inversion without the supervised machine learning model.

In another aspect combinable with any of the previous aspects, the unsupervised machine learning model includes a k-means clustering model, a fuzzy c-means clustering model, or a hierarchical clustering model.

In another aspect combinable with any of the previous aspects, generating the inversion models and forward modeling data includes a reinforcement machine learning model having a long term reward including a misfit reduction of a current model as compared with a model from a prior iteration.

In another aspect combinable with any of the previous aspects, generating a reduced seismic dataset includes applying an active learning model to determine a number of clusters to be formed by the unsupervised machine learning model.

In another aspect combinable with any of the previous aspects, the active learning model determines the number of clusters based on a root mean square of each cluster formed by the unsupervised machine learning model.

Another aspect combinable with any of the pervious aspects includes transforming the seismic data to amplitude and phase data for use by the unsupervised and supervised machine learning models.

In another aspect combinable with any of the previous aspects, generating a reduced seismic dataset comprises randomly selecting samples from each cluster of a plurality of clusters formed by the unsupervised machine learning model.

Another aspect combinable with any of the previous aspects includes iteratively performing generating inversion models and forward modeling data, training the supervised machine learning model, and predicting seismic velocities.

Another aspect combinable with any of the previous aspects includes forward modeling the predicted seismic velocities; determining a data misfit between the forward modeled predicted seismic velocities and the seismic data; extracting data from the forward modeled predicted seismic velocities having large data misfits; and adding the extracted data to the reduced seismic dataset.

In another example implementation, a system for predicting seismic velocities for a subsurface formation includes at least one processor and a memory storing instructions that when executed by the at least one processor cause the at least one processor to perform operations including obtaining seismic data from a subsurface formation, the seismic data including an amount of information about the seismic formation; generating a reduced seismic dataset by applying an unsupervised machine learning model to cluster the seismic data, the reduced seismic dataset having less data than the seismic data, the reduced seismic dataset including the amount of information about the subsurface formation; generating inversion models and forward modeling data by performing a full waveform inversion for the reduced seismic dataset, wherein the inversion models specify velocities in the subsurface formation and the forward modeling data specify response values of the inversion models; training a supervised machine learning model using the inversion models and the forward modeling data; and predicting seismic velocities by providing the seismic data as input to the trained supervised machine learning model.

In an aspect combinable with the example implementation, the operations further include generating, based on the predicted seismic velocities, a seismic image having an improved resolution, resulting from performing the full waveform inversion and relative to seismic images generated without performing full waveform inversion, where generating the seismic image has a reduced computation cost relative to performing full waveform inversion without the supervised machine learning model.

In another aspect combinable with any of the previous aspects, the unsupervised machine learning model includes a k-means clustering model, a fuzzy c-means clustering model, or a hierarchical clustering model.

In another aspect combinable with any of the previous aspects, generating labeled training data includes a reinforcement machine learning model having a long term reward including a misfit reduction of a current model as compared with a model from a prior iteration.

In another aspect combinable with any of the previous aspects, generating a reduced seismic dataset comprises applying an active learning model to determine a number of clusters to be formed by the unsupervised machine learning model.

In another aspect combinable with any of the previous aspects, the active learning model determines the number of clusters based on a root mean square of each cluster formed by the unsupervised machine learning model.

In another example implementation, one or more non-transitory, machine-readable storage devices storing instructions for predicting seismic velocities for a subsurface formation, the instructions being executable by one or more processors, to cause performance of operations including obtaining seismic data from a subsurface formation, the seismic data including an amount of information about the seismic formation; generating a reduced seismic dataset by applying an unsupervised machine learning model to cluster the seismic data, the reduced seismic dataset having less data than the seismic data, the reduced seismic dataset including the amount of information about the subsurface formation; generating inversion models and forward modeling data by performing a full waveform inversion for the reduced seismic dataset, wherein the inversion models specify velocities in the subsurface formation and the forward modeling data specify response values of the inversion models; training a supervised machine learning model using the inversion models and the forward modeling data; and predicting seismic velocities by providing the seismic data as input to the trained supervised machine learning model.

In an aspect combinable with the example implementation, the operations include generating, based on the predicted seismic velocities, a seismic image having an improved resolution, resulting from performing the full waveform inversion and relative to seismic images generated without performing full waveform inversion, where generating the seismic image has a reduced computation cost relative to performing full waveform inversion without the supervised machine learning model.

In another aspect combinable with any of the previous aspects, the operations include iteratively performing generating inversion models and forward modeling data, training the supervised machine learning model, and predicting seismic velocities.

In another aspect combinable with any of the previous aspects, the operations include forward modeling the predicted seismic velocities; determining a data misfit between the forward modeled predicted seismic velocities and the seismic data; extracting data from the forward modeled predicted seismic velocities having large data misfits; and adding the extracted data to the reduced seismic dataset.

What is claimed is:

1. A method for predicting seismic velocities for a subsurface formation, the method comprising:
obtaining seismic data from a subsurface formation, the seismic data including an amount of information about the seismic formation;
generating a reduced seismic dataset by applying an unsupervised machine learning model to cluster the seismic data, the reduced seismic dataset having less data than the seismic data, the reduced seismic dataset including the amount of information about the subsurface formation;
generating inversion models and forward modeling data by performing a full waveform inversion for the reduced seismic dataset, wherein the inversion models specify velocities in the subsurface formation and the forward modeling data specify response values of the inversion models;
training a supervised machine learning model using the inversion models and the forward modeling data; and
predicting seismic velocities by providing the seismic data as input to the trained supervised machine learning model.

2. The method of claim 1, further comprising:
generating, based on the predicted seismic velocities, a seismic image having an improved resolution, resulting from performing the full waveform inversion and relative to seismic images generated without performing full waveform inversion,
wherein generating the seismic image has a reduced computation cost relative to performing full waveform inversion without the supervised machine learning model.

3. The method of claim 1, wherein the unsupervised machine learning model comprises a k-means clustering model, a fuzzy c-means clustering model, or a hierarchical clustering model.

4. The method of claim 1, wherein generating the inversion models and the forward modeling data comprises a reinforcement machine learning model having a long term reward comprising a misfit reduction of a current model as compared with a model from a prior iteration.

5. The method of claim 1, wherein generating a reduced seismic dataset comprises applying an active learning model to determine a number of clusters to be formed by the unsupervised machine learning model.

6. The method of claim 5, wherein the active learning model determines the number of clusters based on a root mean square of each cluster formed by the unsupervised machine learning model.

7. The method of claim 1, further comprising:
transforming the seismic data to amplitude and phase data for use by the unsupervised and supervised machine learning models.

8. The method of claim 1, wherein generating a reduced seismic dataset comprises randomly selecting samples from each cluster of a plurality of clusters formed by the unsupervised machine learning model.

9. The method of claim 1, further comprising:
iteratively performing generating inversion models and forward modeling data, training the supervised machine learning model, and predicting seismic velocities.

10. The method of claim 9, further comprising:
forward modeling the predicted seismic velocities;
determining a data misfit between the forward modeled predicted seismic velocities and the seismic data;
extracting data from the forward modeled predicted seismic velocities having large data misfits; and
adding the extracted data to the reduced seismic dataset.

11. A system for predicting seismic velocities for a subsurface formation, the system comprising:
at least one processor and a memory storing instructions that when executed by the at least one processor cause the at least one processor to perform operations comprising:
obtaining seismic data from a subsurface formation, the seismic data including an amount of information about the seismic formation;
generating a reduced seismic dataset by applying an unsupervised machine learning model to cluster the seismic data, the reduced seismic dataset having less data than the seismic data, the reduced seismic dataset including the amount of information about the subsurface formation;
generating inversion models and forward modeling data by performing a full waveform inversion for the reduced seismic dataset, wherein the inversion models specify velocities in the subsurface formation and the forward modeling data specify response values of the inversion models;
training a supervised machine learning model using the inversion models and the forward modeling data; and
predicting seismic velocities by providing the seismic data as input to the trained supervised machine learning model.

12. The system of claim 11, wherein the operations further comprise:
generating, based on the predicted seismic velocities, a seismic image having an improved resolution, resulting from performing the full waveform inversion and relative to seismic images generated without performing full waveform inversion,
wherein generating the seismic image has a reduced computation cost relative to performing full waveform inversion without the supervised machine learning model.

13. The system of claim 11, wherein the unsupervised machine learning model comprises a k-means clustering model, a fuzzy c-means clustering model, or a hierarchical clustering model.

14. The system of claim 11, wherein generating the inversion models and the forward modeling data comprises a reinforcement machine learning model having a long term reward comprising a misfit reduction of a current model as compared with a model from a prior iteration.

15. The system of claim 11, wherein generating a reduced seismic dataset comprises applying an active learning model to determine a number of clusters to be formed by the unsupervised machine learning model.

16. The method of claim 15, wherein the active learning model determines the number of clusters based on a root mean square of each cluster formed by the unsupervised machine learning model.

17. One or more non-transitory, machine-readable storage devices storing instructions for predicting seismic velocities for a subsurface formation, the instructions being executable by one or more processors, to cause performance of operations comprising:
obtaining seismic data from a subsurface formation, the seismic data including an amount of information about the seismic formation;
generating a reduced seismic dataset by applying an unsupervised machine learning model to cluster the seismic data, the reduced seismic dataset having less data than the seismic data, the reduced seismic dataset including the amount of information about the subsurface formation;
generating inversion models and forward modeling data by performing a full waveform inversion for the reduced seismic dataset, wherein the inversion models specify velocities in the subsurface formation and the forward modeling data specify response values of the inversion models;
training a supervised machine learning model using the inversion models and the forward modeling data; and
predicting seismic velocities by providing the seismic data as input to the trained supervised machine learning model.

18. The non-transitory, machine-readable storage devices of claim 17, wherein the operations further comprise:
generating, based on the predicted seismic velocities, a seismic image having an improved resolution, resulting from performing the full waveform inversion and relative to seismic images generated without performing full waveform inversion,
wherein generating the seismic image has a reduced computation cost relative to performing full waveform inversion without the supervised machine learning model.

19. The non-transitory, machine-readable storage devices of claim 17, wherein the operations further comprise:
iteratively performing generating inversion models and forward modeling data, training the supervised machine learning model, and predicting seismic velocities.

20. The non-transitory, machine-readable storage devices of claim 19, wherein the operations further comprise:
forward modeling the predicted seismic velocities;
determining a data misfit between the forward modeled predicted seismic velocities and the seismic data;
extracting data from the forward modeled predicted seismic velocities having large data misfits; and
adding the extracted data to the reduced seismic dataset.
